(19) United States
(12) Patent Application Publication
(10) Pub. No.: US 2005/0075988 A1
(43) Pub. Date: Apr. 7, 2005

(54) System and method for automated mailing address error detection and correction

(75) Inventors: Robert A. Cordery, Danbury, CT (US); Leon A. Pintsov, West Hartford, CT (US)

Correspondence Address: Ronald Reichman;Pitney Bowes Inc., 35 Waterview Drive, P.O. Box 3000, Shelton, CT, 06484, US

(73) Assignee: Pitney Bowes Incorporated, Stamford, CT (US)

(21) Appl. No.: 10/895,559

(22) Filed: Jul. 21, 2004

Related U.S. Application Data
(60) Provisional application No. 60/508,947, filed on Oct. 6, 2003.

(51) Int. Cl. G06F 17/60

(52) U.S. Cl. 705/404; 705/411

(57) ABSTRACT

A method that enables the mailer (sender) to automatically receive updated and computerized address information that can be used for automatic, real-time correction of address data in mailer's mailing lists.

This Application claims the benefit of the filing date of U.S. Provisional Application No. 60/508,947 filed Oct. 6, 2003, which is owned by the assignee of the present Application.

### FIELD OF THE INVENTION

The invention relates generally to the field of mail delivery systems and, more particularly, to systems for automatically correcting delivery address information.

### BACKGROUND OF THE INVENTION

Ever since the numeric codification of streets and buildings received general acceptance, an individual's name and the individual's household postal addresses have been linked. The sender of a letter, flat or package, i.e., mail, would deliver a letter, flat or package to the post, that had the correct recipient postal address, and the post would deliver the mail to the street address of the recipient of the mail. A correct recipient postal address for the delivery of the mail to the recipient included the name of the recipient; the street address of the recipient; the city and state of the recipient; and the postal zip code of the recipient. Currently in the United States, there are a total of 143,000,000 delivery points that are comprised of 20,000,000 United States Postal Service (USPS) post office boxes and 123,000,000 home and business delivery points.

Approximately three percent (3%) of letter and flat mail require redirection by the USPS due to incorrect address or inconsistency between the name of the addressee and the physical address. The cost for redirecting the mail significantly adds to the costs of the USPS's operations and adds to the time required to deliver the mail to the recipient.

People use address lists to address their mail, and major commercial mailers use computerized address lists to address their mail. Addresses always consist of two distinct parts: a first part for geographic physical location information, and a second part for personal information not necessarily in direct order when represented on a mail item.

There are significant shifts in population due to migration. This results in continuous need for address data updates. The major difficulty with present postal addressing systems is that mailers (senders of mail) do not have real time access to up-to-date recipient address information. In addition, the method of obtaining computerized address information by commercial mailers frequently depends on oral communication with mail recipients resulting in multiple and difficult to correct errors. Thus, the major difficulty with present postal addressing systems is that mailers (senders of mail) do not have real time access to up-to-date computerized recipient address information.

### SUMMARY OF THE INVENTION

This invention overcomes the disadvantages of the prior art by providing a method that enables the mailer (sender) to automatically receive updated and computerized address information that can be used for automatic, real-time correction of address data in mailers' mailing lists.

Address information that is present in the address block of most mail items (except those that are intended for saturation impersonal mass mailings, sometimes referred to as ‘unaddressed’, for every possible address and, as such, do not contain the name of the intended recipient) consists of two distinctly different parts, namely, Personal Information (PI) and Geographic Information (GI).

PI may consist of the following data elements. At least some of them are necessarily present:

<recipient's name>

<recipient's title>

<company name>

<company division>

<department name>

<internal company location code>

GI may consist of the following data elements:

<vanity name>

<street range (number)>

<street name>

<city name>

<state/province/municipality name>

<Postal or ZIP code>

<Machine-readable postal code>

<country name>

PI by itself has no redundancy with regard to GI and vice-versa. That means that personal information cannot contradict or confirm geographic information and vice versa without access to data external to the mail piece. In other words, knowledge of PI does not reveal any knowledge of GI and vice versa. Thus, PI and GI have to be treated separately and, yet, they both constitute inalienable parts of the postal/mailing address. A major source of problems with addressing systems is that a PI/GI combination creates an “undeliverable as addressed” mail item. Problems with addressing can be classified into three categories:

I. PI is internally inconsistent. For example, there is no person identified by data identifier called <recipient name> that works for this company identified by the data called <company name>.

II. GI is internally inconsistent. For example, there is no structure/house number identified by the data element <street range> on this street identified in the address by data element <street name>, or there is a mismatch between <city name> and <postal code>).

III. PI and GI are mutually inconsistent. For example person <recipient name> does not live at this address <street range> and <street name>.

Two fundamentally basic questions for any computerized addressing system are (1) how to detect address inconsistencies I, II and III; and (2), if it is possible to correct such detected inconsistencies. A process of detection and correction of inconsistencies requires analysis of what party has knowledge of correct information, and what is the best way to communicate this information to the source (sender) to avoid future inconsistencies.

Internal inconsistencies in PI (type I inconsistencies) can be detected at the recipient site by the recipient or another party by comparing PI with a database of PI information where correct and up-to-date information is stored. Frequently, in smaller businesses and households, internal inconsistencies in PI can be detected informally by a human, since there is no computerized database of correct information. In such a case, there is no good automated process to perform corrective action by the sender barring the recipient typing and sending corrective information over, for example, the Internet. Since the consequences of PI inconsistencies in such scenario are insignificant (see discussion below), we do not consider this case. On the other hand, for a larger recipient's establishments where inconsistencies in PI may cause additional cost in internal mail sorting and delivery and where computerized databases of correct information are used, the process of automatic detection of PI inconsistencies and communication of corrective message to the sender can be effectively organized along the same lines as the process described below for the postal environment.

Internal inconsistencies in GI belong to two distinct classes. The first and typically less persistent type is inconsistency that can be detected solely based on the information available on the mail item. A typical example is a mismatch between human-readable <Postal or ZIP code> and <Machine-readable postal code>. The second type is the inconsistencies for example between <Postal or ZIP code> and <street range (number)>, <street name>, <city name>, <state/province/municipality name> that can be detected by using comparison with an appropriate entry in the national address database. Since information in GI is significantly redundant, most inconsistencies can be detected in this manner. Most larger mailers perform such detection and correction using specialized list-processing software frequently called “address hygiene” software. Small mailers sometimes mail items with inconsistent GI because they choose not to employ address hygiene software. Such mail items, if correctable, nevertheless are typically correctly sorted by postal sorting process using address hygiene software without notification to mailers. The present invention provides for such a notification.

Finally, mutual inconsistencies between PI and GI (type III inconsistencies) can be detected only either by comparison with National Change of Address Database (when an inconsistency resulted from planned and reported moves by intended mail recipients) or by capturing information that is local and resides “in the heads of carriers”. In both cases, it is extremely desirable to detect inconsistencies and report a corrective message to senders to avoid future mail items with inconsistent addresses. This is also a subject of the present invention.

It should be expressly noted that not all inconsistencies in the address information have equally serious manifestations for the mail communication system. Specifically, mail items that can not be delivered according to their destination address (known in the postal world as Auras or Undeliverable As Addressed) represent the most serious problem since they would have to be returned to the mailer (at no additional cost to the mailer, but with very significant cost to the postal operator) at least for some classes of service such as First Class, Priority or Express service. These are the problems of internally inconsistent GI. The UAAs typically appear as a result of GI internal inconsistencies that cannot be remedied even by using knowledge of local delivery situation available to mail carrier. On the other hand, mail items that can be delivered despite inconsistent addresses also represent a serious problem since corrective information resulting in corrective action frequently resides in the mind of a mail carrier delivering the mail and, as such, is difficult to capture and use. In this sense, the present invention is aimed first at solving the problem of GI-inconsistent but deliverable addresses.

The PI internal inconsistencies are less troublesome, because they are frequently inconsequential when internal to a company or household delivery process. Since the company or household may successfully correct the internal inconsistency by identifying the proper recipient despite, the presence of an incorrect title or department or internal mail code).

Finally, manifestations of GI-PI mutual inconsistencies are typically addressed by address forwarding systems. This means that GI-PI mutual inconsistencies that result from migration of individuals and businesses can be significantly alleviated when computerized address correction data bases (with consistent PI/GI information) are made accessible to at least large mailers and postal sorting equipment on a near real time basis. This probably takes care of approximately 80% of mail volume that requires forwarding. The remaining approximately 20% is still significant (and according to USPS data may represent about $500 million in unnecessary postal costs), and effectively handling this mail is another object of present invention.

In summary, the present invention is aimed at alleviating some problems and completely solving other problems of GI-inconsistent but deliverable addresses as well as GI-PI mutual inconsistent addresses. In addition, the present invention is aimed at correcting PI inconsistent addresses.

### BRIEF DESCRIPTION OF THE DRAWING

FIG. 1 is a drawing of mail that would be utilized by this invention;

FIG. 2 is a drawing of mail box 20 with a Correct Address Information Record (CAIR) label 23;

FIG. 3 is a drawing of CAIR label 23 with information fields PIᵢ₋₁ PIᵢ, GI;

FIG. 4 is a flow chart of the mail creation process; and

FIG. 5 is a flow chart of the address consistency checking process.

### DETAILED DESCRIPTION OF THE PREFERRED EMBODIMENT

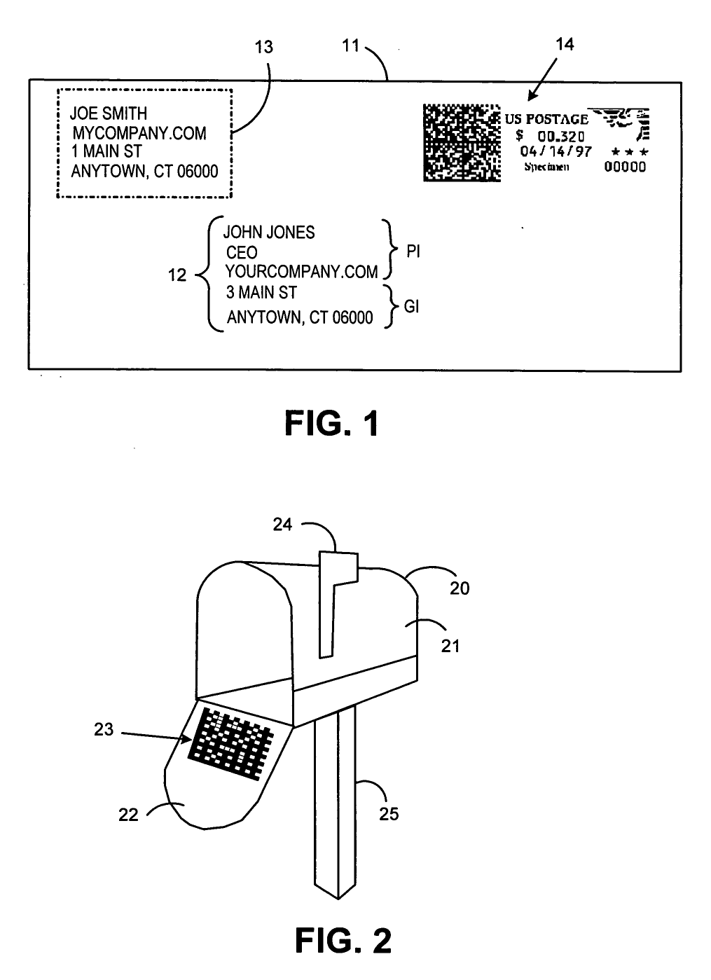

Referring now to the drawings in detail, and more particularly to FIG. 1, the reference character 11 represents mail item, i.e., letter, flat, package, that has a recipient address field 12 that has a PI portion and a GI portion, a SI sender address field 13, and a USPS postal indicia 14.

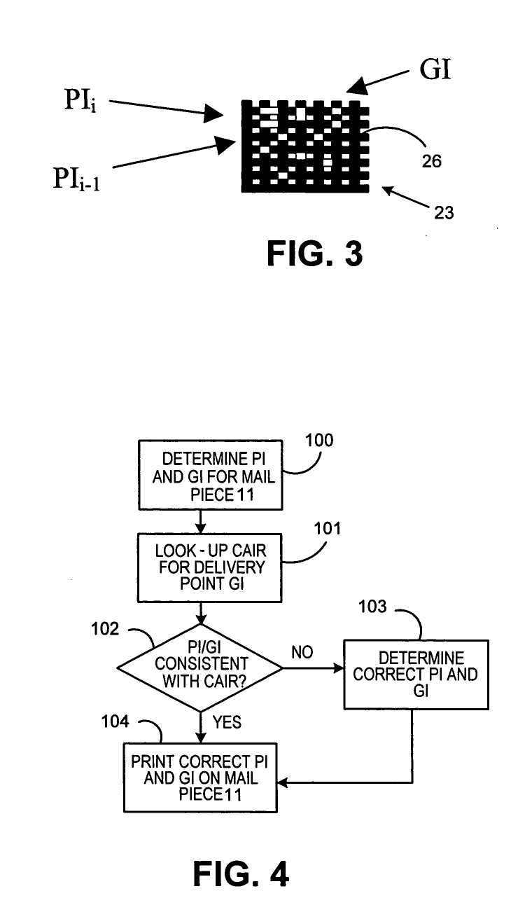

FIG. 2 is a drawing of mail box 20 with a Correct Address Information Record (CAIR) label 23. Mail box 20 has a housing 21 in which mail may be placed and removed, a door 22 having a CAIR label 23 affixed thereto and a mail indicator 24. CAIR label 23 will be more fully described in the description of FIG. 3. Mail box 20 is connected to post member 25.

FIG. 3 is a drawing of Correct Address Information Record (CAIR) label 23 with information fields PIᵢ₋₁, PIᵢ, GI. Label 23 has a two-dimensional bar code 26 (such as Data Matrix) containing correct up-to-date PI/GI information (FIG. 1). Label 23 may be a Radio Frequency Identification Tag, electronic memory chip, read write memory controllable via wireless communication system from user's computer, etc. In the case of the wireless communication, the memory device will be equipped with an antenna. It should be expressly noted that CAIR information can also reside in a computer database accessible by a mail carrier, for example, through a wireless connection device such as a cell phone.

FIG. 4 is a flow chart of the mail creation process. The process begins in step 100 where the PI and GI are determined for mail item 11. Then the program goes to block 101 where the CAIR is looked up for GI. Now the program goes to decision block 102. Decision block 102 determines whether or not PI and GI are consistent with the information obtained from CAIR. If block 102 determines that the PI and GI are not consistent with the information obtained from CAIR, the program goes to block 103 to determine the correct PI and GI. If block 102 determines that the PI and GI are consistent with the information obtained from CAIR or if block 103 determines the correct PI and GI, the program will go to block 104. Block 104 causes the printing of the correct PI and GI on mail 11.

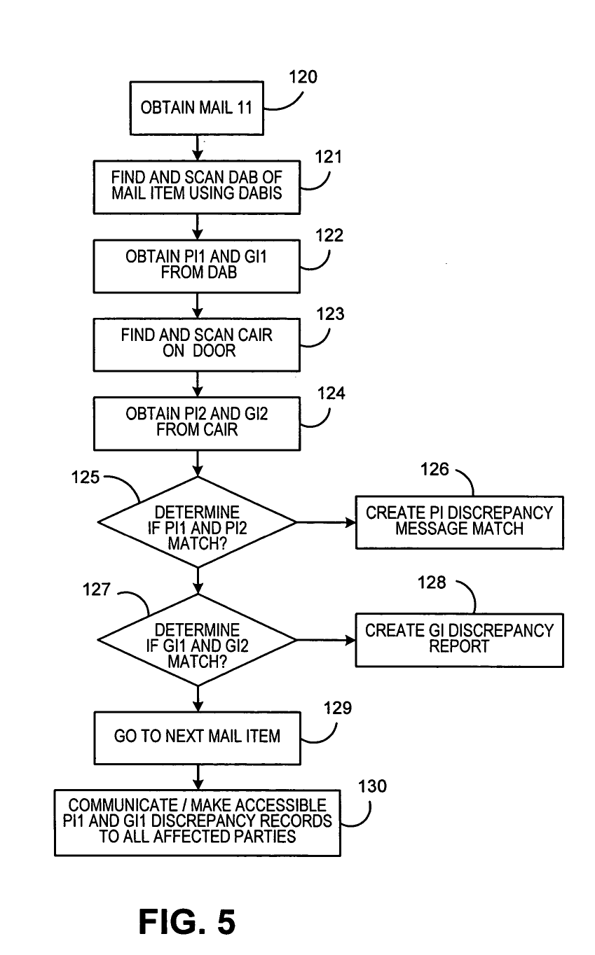

FIG. 5 is a flow chart of the address consistency checking process. The program begins in block 120 where mail 11 is obtained. Then the program goes to block 121 to find and scan the delivery address block of mail item 11 using the delivery address block (dab) information scanner. Now the process continues at block 122 to obtain PI1 and GI1 from the address block data. Next the process goes to block 123, to find and scan CAIR 23 on door 22. Then the process goes to block 124 to obtain PI2 and GI2 from CAIR 23. Then the process goes to decision block 125 to determine whether PI1 and PI2 match. If block 125 determines that PI1 and PI2 do not match, the process goes to block 126 to create a PI discrepancy message. If block 125 determines that PI1 and PI2 match, the program goes to decision block 127 to determine whether or not GI1 and GI2 match. If block 127 determines that GI1 and GI2 do not match, the process goes to block 128 to create a GI discrepancy record. If block 127 determines that GI1 and GI2 match, the process goes to block 129 to obtain the next mail item. Then the program goes to block 130 to communicate and make accessible PI and GI discrepancy records to all affected parties.

GI represents geographical postal address information. PIᵢ represents personal information describing all current mail recipients associated with the postal address GI. PIᵢ₋₁ similarly describes all mail recipients who were associated with the address GI during the immediately preceding period of time. It should be expressly noted that this invention may be extended to other preceding periods, i.e., PIᵢ₋₂ or PIᵢ₋₃ as long as it is desired. The USPS and any post in general may use the present invention as a basis for fee-based services in the case when a previous resident identified by data element PIᵢ₋₁ of the address GI wants to extend mail forwarding period beyond the normally arranged period. When a new resident occupies the dwelling serviced by mail box 20, a new CAIR 23 is computed. One method of computation for CAIR 23 may be a web-based service whereby a new resident enters all required GI and PI into the service web site. The server associated with such web site then computes CAIR including all required and preferred data representation (2D bar code label, RFID and/or other desired storage media), and allows the resident to create a physical representation of the CAIR, for example, by printing a laminated CAIR label 23. Label 23 is then attached by the resident to mail box 20 (FIG. 2). It should be noted that hand-held data capture devices carried by mail carriers, i.e., scanners, are adapted to interpret the data contained in such created CAIR without any additional programming.

It would be obvious to one skilled in the art that CAIR label 23 may be created by the post or by an independent third party as a separate service.

As stated above, the main targets of the present invention are mail items that (a) have internally inconsistent but correctable GI or mutually inconsistent PI and GI and (b) have escaped correction during mail sorting process at mail processing plants due to a lack of corrective computerized information at mail sorting time. These items are transported from mail processing plants to local delivery offices for final delivery. We shall refer to these items as Address Correctable Items or ACI.

All ACI have printed or written or otherwise attached Delivery Address Block Information (DABI). For the purpose of the present invention, we assume that DABI can be captured automatically, parsed and interpreted by computerized equipment operated by the mail delivery clerk (mail carrier) (and this is the preferred embodiment) or key-entered into a computer system. In practice, this means that all mail carriers are equipped with hand-held scanners that can capture, parse and interpret DABI. We shall refer to such scanners as Delivery Address Block Information Scanners or DABIS. It should be noted that such scanners are readily available and could be quickly deployed by postal operators.

The system of the present invention requires also that all delivery points (mail boxes, businesses or offices locations) have correct computerized PI/GI information uniquely indicative of the delivery point and accessible for automatic capture. This means that when a new inhabitant moves to an existing house or an office building or when a new house or an office building has been built, the local post office creates and distributes to the owner of the house or office or their agents a label (or RFID Tag) or any other appropriate physical record containing correct and computerized PI/GI information. This can be done, for example, by printing laminated adhesive labels with two-dimensional bar code (such as Data Matrix) containing correct up-to-date PI/GI information (FIG. 1). We shall refer to this record as Correct Address Information Record or CAIR. The CAIRs can be distributed in many ways: physically using mail; electronically over the Internet; or through a specialized courier. It should be expressly noted that creation, distribution and attachment of CAIRs to mail boxes or other mail receptacles is a one-time activity and does not have to be repeated for every delivery as long as the information in the CAIR is current and consistent. The main purpose of CAIR is to create computerized correct updated PI/GI information at the local level where and when this information is most readily available.

There are two possible cases (based on the USPS delivery system):

Case 1. All mail intended for delivery by a mail carrier responsible for a given carrier route is delivered to a local delivery office already presorted to the walk sequence level. That means that the carrier does not have to sort mail by either casing it or using a piece of automated sorting equipment known in US as Carrier Sequence Bar Code Sorter (CSBCS). In this case, the carrier has only to load already sorted mail into delivery vehicle and deliver mail in accordance to delivery points (stops) along the carrier route. If all delivery receptacles are equipped with CAIRs and all carriers are equipped with DABIS as required, the mail carrier then executes the following process.

For each mail item that is determined by the carrier to have some inconsistent GI or PI/GI information, the carrier first scans mail item with DABIS and then scans CAIR attached to a mail receptacle also using the same DABIS. As a result, two computerized records of the mail item and mail receptacle address data are created in the DABIS. The DABIS can then process these records to identify all inconsistencies according to the flow chart in FIG. 5 and create a correction record or send these records for further processing to the mailer and central postal processing computer (server). In either case, there is a computerized record created that can be used for automatic correction of address data bases, particularly those that are controlled and used by mailer. This is a major aim of the present invention.

Case 2. All mail intended for delivery by a mail carrier responsible for a given carrier route is delivered to a local delivery office already presorted to the carrier route level. In this case, the carrier would typically use either a manual casing process for sorting mail to walk sequence level or a CSBCS. If carrier uses CSBCS, then the correction process is executed in exactly the same way as it is described in the Case 1 above. If the mail carrier uses a manual casing process, then there is an option to have CAIR labels attached to the individual cases (cells in a cage case) since, in this case, they simply emulate delivery point receptacles. Otherwise, the process proceeds as described in the Case 1.

There are many possible extensions and variations with the method and system of present invention. For example, CAIR may contain not only PI of the present, correct owner of the mail receptacle but also the current PI of the previous owner, thus giving additional information to the sender needed for corrective actions. Similarly, CAIR may contain a new GI for the previous owner of the delivery receptacle thus allowing automatic address correction by a mailer for mail that would otherwise require an expensive forwarding process.

There is redundancy in the address. Certain possible addresses are valid. Others are invalid because, for example, the city and postal ZIP code may not match. This is similar to error correction codes. The postal service uses redundancy to correct addresses. If the address is close enough, the mail carrier can deliver it to the correct address. There are four types of consistency:

1. Consistent

2. Automatically correctable

a. Inconsistent address

b. Change of address

3. Correctable by the mail carrier through his personal knowledge

4. Uncorrectable

National Change Of Address (NCOA) database will be operatively connected to the mail sorting machine. They use the address to see if the person moved. For each physical mailing address there is one correct mailing address. For each correct mailing address there are many automatically correctable incorrect addresses.

A business could construct an address database using their own customer data and multiple public sources, such as the phone book, credit information, etc. Inconsistencies can arise between elements of the GI. Ultimately, consistency of an address is determined by matching the address to the time-dependent national address database. The national address database can be used to correct class 1 inconsistencies.

If someone moves and does not inform the postal service, the mail carrier may recognize the problem, or a person at the delivery address will return the mail marked with “no such person at this address”, or the mail will be discarded by the USPS.

If a change of address form is filled out incorrectly, it can be corrected automatically, or may require manual intervention by the USPS.

The CAIR at a delivery address may have the following information: PI_{I-1}, PI_I and GI. The CAIR alternatively may contain a link to a database containing the information. A mail piece arriving at the destination address has PI, GI and SI (sender information, i.e., address, e-address, etc.)

In the event all mail for a given GI is automatically bundled prior to delivery, the recipient is then the only one who can identify the incorrectly addressed mail. If a RFID tag contains PI/GI, then it can be checked without separating the bundle. Alternatively, the RFID tag attached to the bundle could be only on valuable mail pieces. Alternatively, the bundling system could produce a label with PI/GI information on the bundle.

The system can make use of ID tags (presently printed on the reverse side of the envelope) as uniquely indicative of a mail piece and linked with computerized address information stored in the postal database. In this case, DABIS can simply be used by a mail carrier to scan an ID tag and send this information together with CAIR for further processing to a central postal processor.

A similar process would work for any track and trace number or any unique mail item identifier in general, as long as it is linked with computerized address information stored in the postal or other suitable database. However, ID tags are typically linked only with GI, not PI so that the process using ID tags for this reason currently would be limited only to correcting inconsistencies in the GI portion of the address.

If all information obtained from the DAB and CAIR using the process described in the present invention can be stored in a computer system typically employed at local delivery post offices, then information in the computer system may be made accessible to all interested users (parties within postal communication system). This can be done via web services or in a number of other ways including service for a fee.

The above specification describes a new and improved method for enabling a mailer to automatically receive updated address information that may be used for automatic, real-time correction of address data in mailer's mailing lists. It is realized that the above description may indicate to those skilled in the art additional ways in which the principles of this invention may be used without departing from the spirit. It is, therefore, intended that this invention be limited only by the scope of the appended claims.

1. A method that enables a mailer (sender) to automatically receive updated and computerized address information, said method comprises the steps of:
(A) creating by a mailer mail containing delivery address information that includes a personal and geographic portion of the address;
(B) creating an updated delivery address using the latest computerized delivery address information including personal and geographic portions of the address;
(C) capturing the mailer's created delivery address information and the updated delivery address information;
(D) comparing the mailer's created delivery address information and the updated delivery address information;
(E) placing a Correct Address Information Record that contains correct up to date recipient personal and geographic address information in the recipient mail box. and
(F) creating a discrepancy message for personal and geographic portions of delivery address information using the Correct Address Information Record that can be used for automatic, real-time correction of address data in mailer's mailing lists.

2. The method claimed in claim 1, further including the step of: communicating the discrepancy message to the mailer.

3. The method claimed in claim 1, further including the step of: communicating the discrepancy message to a post.

4. The method claimed in claim 1, further including the step of: communicating the discrepancy message to a third party.

5. The method claimed in claim 1, wherein the Correct Address Information Record is in the form of a label.

6. The method claimed in claim 1, wherein the Correct Address Information Record is in the form of a bar code.

7. The method claimed in claim 5, wherein the Correct Address Information Record is in the form of a radio frequency identification tag.

8. The method claimed in claim 1, wherein the Correct Address Information Record is electronically accessible.

9. The method claimed in clam 8, wherein the Correct Address Information Record is accessible over the Internet.

10. The method claimed in claim 8, wherein the Correct Address Information Record is accessible over a cellular phone.
